(19) United States
(12) Patent Application Publication
(10) Pub. No.: US 2009/0040898 A1
(43) Pub. Date: Feb. 12, 2009

(54) METHOD AND DEVICE FOR SIMULATING A MULTI-LAYER OPTICAL STORAGE MEDIUM

(75) Inventors: Kazuyoshi Arai, Kanagawa-ken (NL); Kazuhiro Miyamae, Kanagawa-ken (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,945

(22) PCT Filed: Aug. 19, 2005
(86) PCT No.: PCT/IB05/52733

§ 371 Date: Feb. 20, 2007

(30) Foreign Application Priority Data
Aug. 23, 2004 (EP) 04104043.7

(51) Int. Cl. G11B 27/36; G11B 3/74; G11B 3/64

(52) U.S. Cl. 369/53.41; 369/94; 369/84; G9B/3.108; G9B/3.097; G9B/27.052

(57) ABSTRACT

A method, a device, and a computer-readable medium for simulating a multilayer optical storage medium are disclosed. A multiple-layer optical storage medium is simulated by using a set of multiple single-layer media, wherein the number of multiple single-layer media is equal to or smaller than the number of multiple layers of the multiple layer optical storage medium, and each single layer of the set of multiple single-layer media comprises a copy of the corresponding layer of the multiple-layer medium. This is transparent to any application software accessing a device having such a single-layer medium inserted therein by the drive reporting to the application that a multi-layer optical storage medium has actually been inserted into the device for reading or writing. The device may be comprised in an audio-visual player and/or a recorder such as a DVD recorder.

### FIELD OF THE INVENTION

The invention relates in general to the field of optical storage media. More particularly, the invention relates to a method and device for simulating a multi-layer optical storage medium and, in a particular embodiment, to an audio-visual playing and/or recording apparatus comprising such a device.

### BACKGROUND OF THE INVENTION

Optical storage media are widespread and used for storing very large amounts of digital information, which represents, for example, music, video, images or digital data. Video content may be provided on, for example, DVDs (Digital Versatile Discs) available in single-layer DVDs having 4.7 GB of storage capacity or dual-layer DVDs, i.e. multi-layer DVDs having two layers, with a total storage capacity of 9.4 GB. Recordable DVDs that are used today are generally single-layer DVDs because recorders and recordable media for dual-layer DVDs are much more expensive. Therefore, one known solution is to copy one dual-layer DVD onto two single-layer DVDs.

A commercially available software package fulfilling this purpose is ‘DVD to DVD Copy’ from the ProDVD Corporation in Cherry Hill. The software provides a way to copy the contents from DVDs for archiving and backups. According to the manufacturer, it preserves all existing DVD contents including original menus, trails, previews, and multiple language tracks. It produces a copy of a single-layer DVD onto one blank 4.7 GB DVD, and a copy of a dual-layer DVD onto one blank 4.7 GB DVD with data compression. Furthermore, it copies 9.4 GB dual-layer DVDs onto two 4.7 GB consumer DVD media.

DVD copies made by compressing the contents of one dual-layer DVD onto one single-layer DVD having half the storage capacity of DVD copies resulting from dividing and spreading the data contents from one dual-layer DVD onto two single-layer DVDs, for example, with the above-mentioned ‘DVD to DVD Copy’ software, are two independent separate discs and will not run as a whole DVD. These existing applications for copying a double-layer DVD to two single-layer discs have to produce a lot of data for the second disc, like Table of contents, menus, etc. For the first disc, the menus, etc. have to be modified and stored on the first disc. This re-encoding of the data may be time-consuming.

Hence, according to the prior art, single-layer DVDs cannot be used to make an exact copy of dual-layer DVDs. Furthermore, as the reflection of a dual-layer Recordable and/or Rewritable (“-R”) disc is lower than the reflection of a single-layer DVD-R, dual-layer recordable discs decrease the playability of copies made on dual-layer discs on standard DVD players. This problem will further increase when the number of layers increases, i.e. when copying the contents from any multi-layered optical storage medium to multiple single-layer optical storage media, e.g. BluRay discs, HD-DVDs or holographical media.

Thus, there is a need for a new method and device of providing copies of multi-layer optical storage media, wherein each layer of a multi-layer medium is copied to a single-layer medium. The resulting copies shall be readable on a standard single-layer or multiple-layer player, wherein only the original data from a master optical storage medium is used, and no processing needs to be done on this original data at all when making the copy. Another object of the invention is that the copies made shall be compatible with any application software accessing the single-layer copied optical storage media as a single multiple-layer optical storage medium. No special application software and re-encoding of the data shall be needed for this purpose, so that the data can be used without any changes with any application software.

### SUMMARY OF THE INVENTION

The present invention overcomes the above-identified deficiencies in the art and solves at least the above-identified problems singly or in combination by providing a method, a device, an optical storage medium, and a computer-readable medium for simulating a multi-layer optical storage medium according to the appended patent claims.

According to one aspect of the invention, a method is provided, comprising the step of simulating a multiple-layer optical storage medium by using a set of multiple single-layer media, wherein the number of multiple single-layer media is equal to or smaller than the number of multiple layers of the multiple-layer optical storage medium having data stored thereon, and each single layer of the multiple single-layer media comprises an exact copy of the corresponding layer of the multiple-layer medium, and the further step of reporting to an application software accessing a device having a single-layer medium of said set inserted therein that a multi-layer optical storage medium is inserted in the device for reading or writing.

According to another aspect of the invention, an optical storage medium is provided, having a single recordable or rewritable layer for data storage comprising information in its headers or physical information stored on it during single-layer optical medium recording configured to indicate a multiple-layer simulation operation mode to a drive for accessing said medium.

According to yet another aspect of the invention, a device for simulating a multi-layer optical storage medium is provided. The device is adapted to simulate a multiple-layer optical storage medium by using multiple single-layer media, wherein the number of multiple single-layer media is preferably equal to (when all layers of the master have data stored thereon) or smaller than (when at least one layer of the master is empty) the number of multiple layers of the master multiple-layer optical storage medium, and each single layer of the multiple single-layer media comprises a copy of the corresponding layer of the multiple-layer medium. If multiple-layer optical media are partially empty, fewer single-layer optical media may be used as no single-layer medium is needed for a layer of a multiple-layer optical medium having no data stored thereon. An application software will not try to access such an empty layer and therefore there will be no request for inserting an empty single-layer medium. The copy may be an exact copy or the layer may contain further information, such as data indicating the type of copy or the number of the layer stored on the medium. Furthermore, the device comprises means for simulating a multiple-layer medium, wherein said means are configured to report to an application software accessing the device for reading or writing from/to said multiple-layer medium that a multi-layer optical storage medium is inserted in the device when a single-layer medium has been inserted in the device.

According to a further aspect of the invention, a computer-readable medium having embodied thereon a computer program for processing by a processing device of a drive for playing and/or recording of optical storage media is provided. The computer program comprises code segments for simulating that a multi-layer optical storage medium is inserted in the drive. A first code segment is provided for simulating a multiple-layer optical storage medium by using a set of multiple single-layer media, wherein the number of multiple single-layer media of said set is equal to or smaller than the number of multiple layers of the multiple-layer optical storage medium, and each single-layer medium of said set comprises a copy of the corresponding layer of the multiple-layer medium. Furthermore, a second code segment is provided for reporting to an application software accessing a device having a single-layer medium inserted therein that a multi-layer optical storage medium has been inserted in the device for reading or writing. According to a preferred embodiment, the device is comprised in an audio-visual playing and/or recording apparatus such as a DVD recorder.

The present invention has the advantage over the prior art that it allows production of copies of an original optical disc having multiple layers without the need of recordable discs having the same number of multiple layers as the original disc. For example, if dual-layer DVD recordable discs did not exist, the present invention would make it possible to copy a full dual-layer DVD-ROM disc onto two single-layer recordable DVD discs.

More precisely, the advantages are:
a multiple-layer drive is not necessary for recording a copy or for playing a copy made on several single-layer discs: such multiple-layer recording/playback drives for recordable discs may not be available yet for the consumer, or such drives are more expensive and thus less attractive than single-layer recording drives;
Multiple-layer discs are not needed for the copies: as single-layer recordable discs are generally cheaper, this is a further advantage.
No special application software is needed.
It may also be used with an A/V device.
No re-encoding of the data is needed, it can be used without any changes.

### BRIEF DESCRIPTION OF THE DRAWINGS

Further objects, features and advantages of the invention will become apparent from the following description of embodiments of the present invention with reference to the accompanying drawings, in which

FIG. 1 is a flow chart illustrating an embodiment of the method according to the invention,

FIG. 2 is a flow chart illustrating another embodiment of the method according to the invention,

FIG. 3 is a flow chart illustrating a further embodiment of the method according to the invention,

FIG. 4 is a schematic illustration of an embodiment of the device according to the invention, and

FIG. 5 is a schematic illustration of an embodiment of the computer-readable medium comprising a program code of the invention.

### DESCRIPTION OF EMBODIMENTS

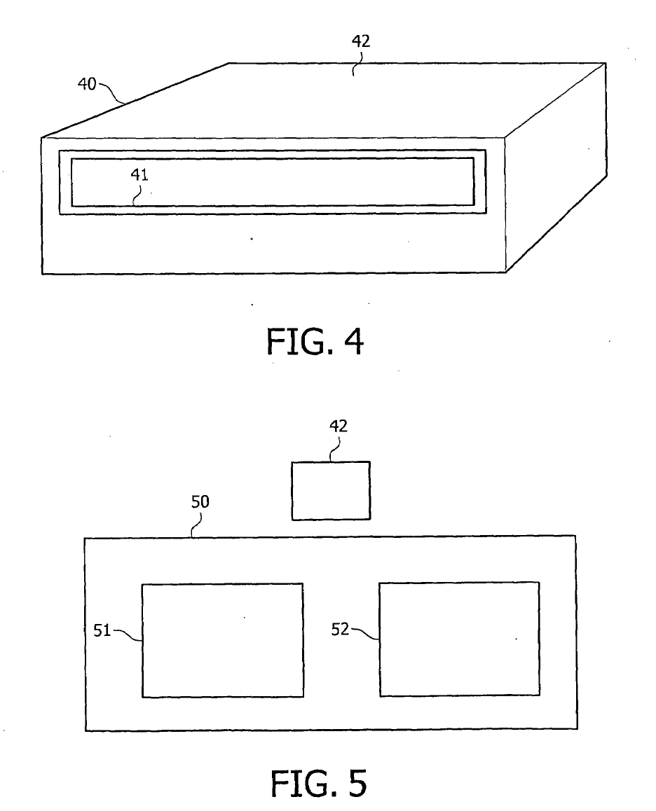

According to an embodiment of the invention, a disc drive 40 for optical media, illustrated in FIG. 4, is provided that is adapted to make an exact copy of the data stored on each layer of a dual-layer optical medium of the same type, e.g. an optical disc of the DVD type. The drive 40 has a tray 41 for inserting discs into the drive. Alternatively, the drive may have a disc changer system into which a plurality of discs can be inserted for automatically accessing one disc at a time, or alternatively the disc may be housed inside a cartridge means that protects the disc from being accessed outside the drive, wherein the cartridge replaces the above-mentioned tray of the drive. Furthermore, the drive 40 has a processing device 42 (inside the housing of the illustration) for processing software controlling the drive 40.

However, the case of an optical medium having two layers is only given for easier understanding of the invention. The same principle applies to multi-layer optical media. Furthermore, other optical media such as BluRay discs, HD-DVDs or holographical media having multiple layers are also considered to be within the scope of the appended patent claims.

As mentioned above, it has hitherto only been possible to copy the data that is contained on one dual-layer medium onto two single-layer media. Still, if a conventional application expects to see one dual-layer medium, it cannot handle two single-layer media instead.

According to the present embodiment of the invention, the drive is adapted to simulate a dual-layer medium, by using two single-layer media, while this is transparent for the application. The application sees no difference between this situation and a ‘real’ dual-layer medium. An exact copy of the data stored on the first layer of the dual-layer disc is recorded on a single-layer (re)writable medium, hereinafter called “disc 1”, and an exact copy of the data stored on the second layer of the dual-layer disc is recorded on a single-layer (re)writable disc, hereinafter called “disc 2”. Additional data may be added to the copied data on disc 1 and/or disc 2 during copying, e.g. information concerning the identification of the disc set as, for example, “disc 1 of 2”. The aforementioned recording method used by the drive is comprised in an embodiment of a method according to the invention and will be described in more detail below.

If the user inserts disc 1, the drive is adapted to automatically detect that this is disc 1 from a ‘simulated dual-layer disc set’, and it reports to the application that a “real” dual-layer disc has been inserted. As long as the application only accesses the first layer of the “real” dual-layer disc, disc 1 is used as if it were the first layer of a copy of the “real” dual-layer disc.

As soon as the application tries to access the second layer of the “real” dual-layer disc that the application thinks it is using, the drive will open the tray, and prompt the user to insert disc 2, without the application knowing this. The user may be prompted in various ways, for example, by a pop-up window displaying a message to insert the correct disc, and a button in the window on which the user clicks when the correct disc is inserted. Furthermore, the aforementioned opening of a tray is merely an example of a specific embodiment for enabling the player to physically get access to another disc. Alternative ways of changing discs may be, for example, a disc changer system, which automatically changes discs without manual user intervention. The application now thinks that it is accessing the second layer of the “real” dual-layer disc, while in reality we use the second single-layer copy, disc 2.

If the application subsequently switches back to the first layer, the drive will again prompt the user to switch discs, and so forth.

If the user wants to create a ‘simulated dual-layer disc set’, i.e. to make a copy of a dual-layer disc, the user has to tell the drive to switch to the ‘dual-layer simulation recording’ operation mode. This may be performed by pressing a button on the drive or by checking a software button via a graphical user interface (GUI) of the burning software. Such a button or GUI are only possible options, and other solutions may be chosen by the skilled person, like sending a specific command to the drive, which is, for example, what the GUI performs in a software layer transparent to the user. Alternatively, this operation mode may be activated by inserting a ‘special’ single-layer disc adapted to ‘dual-layer simulation recording’. If the user now inserts an empty single-layer disc (or the ‘special’ single-layer disc), the drive reports back that a recordable dual-layer disc has been inserted, and will produce a two-disc single-layer simulated copy to be used in the above-mentioned scenario. The user is instructed to switch discs when needed, i.e. the master dual-layer disc is inserted into the drive and the first and second layers are read onto a mass storage device providing temporary memory space, e.g. a hard disk drive. This step of copying the layers may be performed by reading the entire layers at once, or alternatively by an alternating read/write process with parts of the data stored on the layers being transferred to the temporary memory and the to the single-layer copy, e.g. due to constraints imposed by the size of the temporary memory with regard to the storage capacity of the disc to be copied.

More precisely, the following steps are performed according to the following embodiments of the method according to the invention.

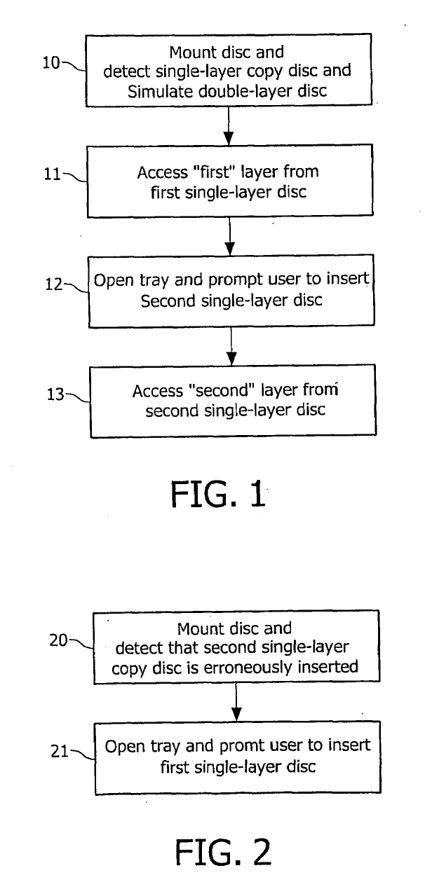

1. When the first disc of a ‘single-layer copy’ of a dual disc is inserted, i.e. when the user inserts the first disc of a ‘simulated dual-layer disc set’, the drive performs the following steps, as illustrated in FIG. 1:

a. When mounting the disc, the drive detects that the disc is a ‘single-layer copy’ disc (step 10).

b. The drive behaves as if a dual-layer disc was inserted: the drive tells the application that a dual-layer disc has been inserted and the application accesses the “first” layer (step 11).

c. Internally, the drive ‘remembers’ that the disc is not really a dual-layer disc. As soon as the application wants to access the second layer, the drive opens that tray (step 12), so that the user inserts the second disc, or alternatively the drive uses the disc changer system for giving the drive access to the second disc, e.g. from a multiple disc magazine or a multiple disc carousel.

2. When the second disc of a ‘single layer copy’ of a dual disc is inserted, i.e. when the user inserts the second disc of a ‘simulated dual-layer disc set’, but he was not prompted by the drive to do so, the drive will see this during mounting (step 20), indicate this, and open the tray (step 21), so that the user can insert the first disc, which usually contains the table of contents. This is illustrated in FIG. 2. Alternatively, in a disc changer, the discs will be switched by the drive and the first disc will automatically be accessed.

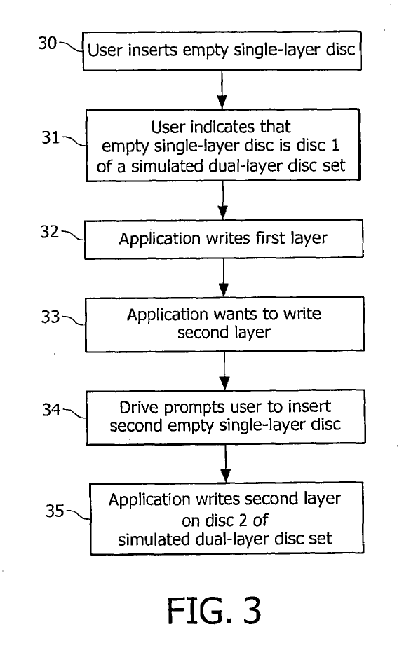

3. When the user wants to create a ‘simulated dual layer disc set’, the following scenario is performed, as illustrated in FIG. 3:

a. The user inserts an empty single-layer (re)writable disc (step 30);

b. The user sends a special command to the drive, telling it that the disc should be handled as ‘disc 1 of a dual layer disc set’ (step 31).

c. After this, the application thinks it is a dual-layer disc, and it may write the data from the first layer of the dual-layer disc onto the single-layer disc in the same way as it would write any ‘normal’ dual-layer disc (step 32).

d. When the application wants to write on the second layer (step 33), the drive prompts (step 34) the user for the second single-layer empty disc, just as above in case 1. Alternatively, the second disc may automatically be accessed in a disc changer system, when a second empty single-layer disc was inserted previously. Subsequently, the application writes the second layer of the dual-layer disc on the second single-layer disc (step 35).

To adapt the drive for performing the above method, the following measures are added to a conventional apparatus. The software of the drive is adapted to handle the ‘simulated dual layer disc set’ as if it were a normal dual-layer disc. The software may detect that the drive is currently not handling a real dual-layer disc but ‘disc 1 or 2 of a simulated dual-layer disc set’ by information from the headers or from the physical disc information stored on the disc during burning.

Furthermore, the software of the drive is adapted in such a way that, whenever the application accesses the other ‘layer’ of the disc set, the drive opens the tray, and prompts the user to insert the other disc. Alternatively, in a disc changer, the other disc is automatically accessed.

An embodiment of the software is illustrated in FIG. 5, wherein the program is stored on a computer-readable medium 50 for processing by a processing device 42 of a drive 40 for playing and/or recording of an optical disc. The computer program comprises code segments 51, 52 for simulating that a dual-layer disc has been inserted in the drive. A first code segment 51 simulates a dual-layer disc by using a set of two single-layer discs. A second code segment 52 reports to an application software accessing the drive 40 that a dual-layer disc has been inserted in the device for reading or writing, although a single-layer disc has been inserted therein.

There are various applications and uses of the above-described method, device and computer program, which include fields such as computer drives for optical media, consumer players and recorders for optical media, such as DVD recordable video recorders, etc.

The present invention has been described with reference to specific embodiments. However, embodiments other than those preferred above are equally possible within the scope of the appended claims, e.g. different numbers of layers of the optical media, different types of media than those described above, performing the above method by hardware or software, etc.

Furthermore, use of the verb “comprise” and its conjugations in this specification does not exclude other elements or steps, while the article “a” or “an” does not exclude a plurality, and a single processor or other units may fulfil the functions of several of the units or circuits recited in the claims.

1. A method of simulating a multi-layer optical storage medium, the method comprising the steps of
simulating a multiple-layer optical storage medium by using a set of multiple single-layer media, wherein the number of multiple single-layer media is equal to or smaller than the number of multiple layers of the multiple-layer optical storage medium having data stored thereon, and each single-layer medium of said set comprises a copy of the corresponding layer of the multiple-layer medium, and
reporting to an application software accessing a device having a single-layer medium of said set inserted therein that a multi-layer optical storage medium has been inserted into the device for reading or writing.

2. A method according to claim 1, wherein said copy of the corresponding layer of the multiple-layer medium on a single-layer medium is an exact copy thereof.

3. A method according to claim 2, wherein said single-layer medium comprises further data stored thereon.

4. A method according to claim 1, wherein the step of reporting being transparent for the application is such that the application sees no difference between the inserted single-layer medium and the multi-layer optical storage medium accessed.

5. A method according to claim 1, wherein a simulated set of multiple single-layer optical media is copied from a multi-layer optical medium, the method comprising the steps of
inserting a first empty single-layer writable or rewritable optical medium into the drive,
indicating to the drive that the single-layer optical medium is to be handled as the first of a multiple-layer media set,
writing the medium with the data from a first layer of a multiple-layer master optical medium in the same way as any layer of a multiple-layer optical medium,
when the application wants to write on the subsequent layer, prompting the user for the subsequent single-layer empty optical medium, and
writing the subsequent single-layer optical medium with the data from a subsequent layer of a multiple-layer master optical medium in the same way as any layer of a multiple-layer optical medium.

6. A method of simulating a multi-layer optical storage medium, the method comprising the steps of
simulating a multiple-layer optical storage medium by using a set of multiple single-layer media, wherein the number of multiple single-layer media is equal to or smaller than the number of multiple layers of the multiple-layer optical storage medium having data stored thereon, and each single-layer medium of said set comprises a copy of the corresponding layer of the multiple-layer medium, and
reporting to an application software accessing a device having a single-layer medium of said set inserted therein that a multi-layer optical storage medium has been inserted into the device for reading or writing, wherein a multiple-layer optical storage medium is simulated by means of a set of multiple single-layer optical media, and wherein the method, when a first single-layer optical medium of a set of single-layer copies made according to the method of claim 5 is inserted into the drive, further comprises the steps of:
the drive detecting that the single-layer optical medium inserted is a ‘single-layer copy’ optical medium,
the drive behaving as if a multiple-layer optical medium was inserted by said reporting step,
the drive remembering that the disc is not really a multiple-layer disc, and,
when the application wants to access another layer of the multiple-layer optical disc, the drive opening its tray and prompting the user to insert a subsequent single-layer optical medium corresponding to that layer of the multiple-layer optical disc.

7. A method according to claim 1, wherein the method, when the drive detects a wrong single-layer optical medium of said set of single-layer optical media being inserted into the drive, further comprises the steps of opening the tray of the drive and prompting the user to insert the correct single-layer optical medium corresponding to the layer of the multiple-layer optical disc to be accessed.

8. A method according to claim 1, wherein said step of simulating is accessed by a user indicating to the drive to switch to a multiple-layer simulation operation mode by pressing a button on the drive, or by checking a software button via a graphical user interface, or by activating this operation mode by inserting a single-layer optical medium adapted to multiple-layer simulation recording, or by inserting a single-layer optical medium recorded in multiple-layer simulation recording mode based on information from the headers or from the physical information stored on the single-layer optical medium during recording.

9. An optical storage medium having a single recordable or rewritable layer for data storage comprising information in its headers or physical information stored on it during single-layer optical medium recording configured to indicate a multiple-layer simulation operation mode to a drive for accessing said medium.

10. An optical storage medium according to claim 9, wherein the medium is chosen from a DVD, a BluRay disc, a HD-DVD, or holographical media.

11. A device (40) for simulating a multi-layer optical storage medium, said device being adapted to simulate a multiple-layer optical storage medium by using a set of multiple single-layer media, wherein the number of multiple single-layer media is equal to or smaller than the number of multiple layers of the multiple-layer optical storage medium, and each single layer of the multiple single-layer media comprises a copy of the corresponding layer of the multiple-layer medium,
said device comprising means for simulating a multiple-layer medium, said means being configured to report to an application software accessing the device for reading or writing from/to said multiple-layer medium that a multi-layer optical storage medium is inserted in the device when a single-layer medium has been inserted in the device.

12. A device for simulating a multi-layer optical storage medium according to claim 11, said device being adapted to automatically detect which layer of the multiple-layer medium is stored on said single-layer optical medium.

13. A device for simulating a multi-layer optical storage medium according to claim 11, wherein the device is comprised in an optical disc drive.

14. A device for simulating a multi-layer optical storage medium according to claim 13, wherein said disc drive comprises a disc changer system.

15. An audio-visual playing and/or recording apparatus comprising a device for simulating a multi-layer optical storage medium according to claim 11.

16. An audio-visual playing and/or recording apparatus according to claim 15, wherein said apparatus is a DVD recorder.

17. A computer-readable medium (50) having embodied thereon a computer program for processing by a processing device (42) of a drive for playing and/or recording of an optical storage medium, the computer program comprising code segments (51, 52) for simulating that a multi-layer optical storage medium is inserted in the drive, comprising
a first code segment (51) for simulating a multiple-layer optical storage medium by using a set of multiple single-layer media, wherein the number of multiple single-layer media of said set is equal to or smaller than the number of multiple layers of the multiple-layer optical storage medium, and each single-layer medium of said set comprises a copy of the corresponding layer of the multiple-layer medium, and
a second code segment (52) for reporting to an application software accessing said drive having a single-layer medium inserted therein that a multi-layer optical storage medium has been inserted into the device for reading or writing.
